(19) United States
(12) Patent Application Publication
(10) Pub. No.: US 2007/0094915 A1
(43) Pub. Date: May 3, 2007

(54) Insect trap for capturing numerous species of the lepidoptera order and method of operation thereof

(76) Inventors: Thomas Alfred Plato, Houston, TX (US); James Clayton Plato, Houston, TX (US); James Scott Plato, League City, TX (US); Stacy Elizabeth Plato, Houston, TX (US); Timothy Bruce Johnson, Langhorne, PA (US)

Correspondence Address: DEFILLO & ASSOCIATES, INC., 4922 EAGLE COVE SOUTH DRIVE, PALM HARBOR, FL, 34685, US

(21) Appl. No.: 11/265,955

(22) Filed: Nov. 3, 2005

(51) Int. Cl. A01M 1/14; A01M 1/02; A01M 1/10

(52) U.S. Cl. 43/114; 43/107

(57) ABSTRACT

The present invention is a three dimensional insect trap, for capturing, numerating, determining population levels and controlling insects by physical trapping, mass trapping and mating disruption. The trap is comprised of a bottom piece, a top piece, a device for hanging pheromones, kairomones or other attractants and an area for either a replaceable component used for mating disruption via auto-dissemination, an adhesive-coated grid-marked floor or a capture reservoir for holding soapy water or oil. The trap can be hung within the insect environment by a device on the top piece or by attachment to a vertical stake or pole by use of support brackets.

### BACKGROUND OF THE INVENTION

1. Field of the Invention

This invention concerns a four or five-piece three-dimensional insect trap and assembly for monitoring, numerating and control by physical capture (mass trapping) or by mating disruption of flying insects. Alternately, the trap can be used to dispense pheromone for the purposes of mating disruption.

2. Description of Related Art

Insect traps are an integral part of integrated pest management systems. Determining the number and presence of pest insect species often determines the timing of control measures and/or the effectiveness of control measures. For some species, such as the cotton boll weevil, insect traps are an important component of a control or eradication program. The standard wing trap and delta traps are typically used for capture and monitoring of destructive insects such as the pink bollworm, omnivorous leaf roller, oblique-banded leaf roller, codling moth, tomato pinworm, beet armyworm, fall armyworm, fruit flies and numerous others. In certain situations, the wing trap and delta trap are not very effective and present certain operational difficulties. In general, these traps are designed to use pheromones or kairomones as an attractant and are structured in such a way to allow for the formation of a chemical plume through two entry/exit portals. This design feature restricts entry of insects to only two openings and has a limited chamber for holding pheromone vapors. Captured insects are often difficult to count and may require the disassembly of the trap for counting purposes. In addition, these traps are designed for monitoring purposes and are not considered sufficiently effective to mass trap insect populations for the purpose of insect control.

Lingren et al., U.S. Pat. No. 6,516,558 is an example of a delta trap that comprises essentially a carton container suited to be assembled into a three dimensional trap, a locking clasp and, optionally, an attachment means for attaching the trap to a place of insect infestation monitoring.

Another similarly shaped trap is Murmatsu, U.S. Pat. No. 5,253,450. The Muramatsu trap that can be constructed from two pieces. The first piece is a multifaceted, hollow chamber that, in a preferred embodiment, is made by cutting a blank from a pliable material such as cardboard and folding it to provide a chamber in the shape of a frustum of a hollow pyramid with a port open to the hollow interior. The second piece is an inlet that, in a preferred embodiment, is made by cutting a blank from a pliable material such as paper having an adhesive on one side. The adhesive paper is cut and folded into the shape of a frustum of a tubular pyramid with tongues projecting outward from an open base.

Numerous traps have been devised for catching flying insects. Many of the prior devices include a one-way entrance passage leading into a holding chamber with the inlet side sufficiently smaller than the width of the chamber to limit the insect from escaping. Representative samples of insect traps are shown in the following U.S. patent:

U.S. Pat. No. 4,551,941 Schneidmiller; U.S. Pat. No. 5,231,792 Warner; U.S. Pat. No. 5,243,781 Carter; U.S. Pat. No. 5,392,560 Donahue et al.; U.S. Pat. No. 5,557,880 Schneidmiller; U.S. Pat. No. 5,987,809 Cheok; U.S. Pat. No. 6,112,454 Plato et al.; U.S. Pat. No. 5,596,833 Harrie et al.; U.S. Pat. No. 5,461,822 Green et al.; U.S. Pat. No. 4,244,135 Harwoods; U.S. Pat. No. 2,014,500 Lass; U.S. Pat. No. 1,924,379 Reese; U.S. Pat. No. 1,858,087 Howard; U.S. Pat. No. 1,786,704 Deibele; and U.S. Pat. No. 1,085,388 Overmyer.

The prior art is replete with flying insect traps of various configurations. Many of these prior flying insect traps are adapted for industrial, commercial, farming and like environments where a large number of flying insects may be encountered and collection of a large-volume of flying insects is desired. Flying insect traps of this type generally use relatively large bags or other volume storage containers for collection of the captured flying insects. Other prior flying insect trap arrangements are relatively complicated as shown in Mayo, U.S. Pat. No. 2,931,127; Brophy et al., U.S. Pat. No. 3,058,257; Weimert et al., U.S. Pat. No. 4,141,173; and Bible, U.S. Pat. No. 5,329,725; Roche, U.S. Pat. No. 3,123,933; and Rueff, U.S. Pat. No. 3,987,578.

Additionally, representative samples of traps more closely related to applicants' invention are shown in the following U.S. patents:

U.S. Pat. No. 249,931 Harned; U.S. Pat. No. 862,467 Gardiner; U.S. Pat. No. 1,059,934 Dodard; U.S. Pat. No. 1,071,578 Rese; U.S. Pat. No. 1,112,064 Gordon; U.S. Pat. No. 1,626,530 Harris; U.S. Pat. No. 3,685,199 Bradshaw; U.S. Pat. No. 3,729,858 Bradshaw; U.S. Pat. No. 3,755,958 Bradshaw; U.S. Pat. No. 3,863,384 Weatherston, et al.; U.S. Pat. No. 4,133,137 Van Adelsburg; U.S. Pat. No. 4,156,321 Capizzi; U.S. Pat. No. 4,442,624 Browne; U.S. Pat. No. 4,961,282 Hoppe; and U.S. Pat. No. 6,161,327 Thomas.

A more efficient trap would allow more accurate determination of population numbers for improved timing for the application of insecticides and determination of the efficacy of a control program. A more efficient trap would allow for the use of mass trapping of low populations in glasshouse crops, warehouses or facilities where commodities are stored and in field and orchard crops. Additionally, an improved trap would offer user-friendly characteristics for easier assembly, servicing, and resistance to windy conditions.

Therefore, the availability of practical, simple and reliable insect traps would allow more accurate determination of an infestation and would be very practical in determining an actual need for the number and frequency of insecticide applications. With certain insect pests such a trap would eliminate the need for remedial chemical control measures by mass trapping or mating disruption of the pest species.

It would, therefore, be important and advantageous to have available a convenient, practical, accurate and reliable insect monitoring trap which would be user friendly, efficacious in attracting and capturing the insect and practical for monitoring of a number of captured insects.

All patents, patent applications and publications cited herein are incorporated by reference.

### SUMMARY OF THE INVENTION

The present invention is a multi-piece three-dimensional and multi-directional insect trap having an improved design that provides a practical, efficient and accurate insect monitoring and capturing system. The present invention is an insect trap that comprises a bottom piece that is either solid or grated; a top piece that is designed to produce four openings and form a chamber for holding pheromone vapors; a hanging device for holding multiple dispensers of pheromones, kairomones, or other attractants; and a replaceable floor panel. The bottom piece can support a floor panel that is marked with square grids and coated with insect-trapping adhesive. As an option, a reservoir filled with soapy water or oil can be substituted for the adhesive-coated floor for capturing insects in mass trapping programs.

A primary object of this invention is to produce an insect trap that is more efficient in the creation of pheromone, kairomone or other attractant odor plumes in the roof chamber and dispersed in multiple directions for the purpose of attracting said insect into the trap whereby it is induced to stay or rest and is captured, killed and/or counted. This invention fulfills this objective with a central chamber for holding pheromone odors and with four entry/exit portals.

Another object of this invention is to produce an insect trap with a replaceable floor coated with adhesive for capturing insects or with a mating disruption device that can be easily replaced or serviced on a routine basis.

Another object of this invention is to produce an insect trap with a replaceable reservoir filled with soapy water or oil for capturing insects for the purpose of counting or mass trapping.

Yet another aspect of this invention is to produce an insect trap that can hold multiple dispensers of pheromones, kairomones or other attractants.

A further object of this invention is to produce an insect trap that may be quickly hand-assembled without using tools or requiring special knowledge or skills and that has components that when damaged may be readily replaced.

A further object of this invention is to produce an insect trap that can be readily dissembled and stored and that has parts that may be compactly stored.

A further object of this invention is to produce a trap that can be used in the field under windy conditions without negative effect to its ability to function.

Additional objects and advantages of the invention will be set forth in part in a detailed description that follows, and in part will be obvious from the description, or may be learned by practice of the invention.

Still yet another aspect of this invention is the insect trap which, in the assembled form, has a shape with four triangular openings, one on each side. The four trap openings permit entry of the insect lured into the trap by the internal pheromone, kairomone or other attractant for practicing mating disruption or for capturing of the insect on the glue coated replaceable floor. The counting of captured insects and the replacement of the glue-coated floor is easily accomplished.

Still another aspect of this invention is a method of use of a four-piece assembled trap as a non-poisonous insect monitoring system useful in detecting and monitoring the population of insects of orders of lepidoptera, diptera, coleoptera, hymenoptera, homoptera, or hemiptera for monitoring a crop infestation and/or capturing the insect. Additionally, the retention of a large number of insects on the glue-coated floor or in the reservoir holding soapy water or oil can effectively result in mass trapping of the population.

These, together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the invention assembled and in an operable orientation.

FIG. 2 is a cross-sectional view of the trap of FIG. 1.

FIG. 3 is a top plan view of the bottom piece in the grated form.

FIG. 3(a) is a cross-sectional view taken along lines A-A of FIG. 3.

FIG. 3(b) is a side view of the bottom piece.

FIG. 3(c) is a top plan view of the bottom piece in the solid form.

FIG. 4 is a right and left side view of the hanging device.

FIG. 5 is a top plan view of the floor panel marked in a grid and coated with glue or adhesive.

FIG. 6 is an isometric view of the assembled trap, tray, holding arms and round and rectangular stakes.

FIG. 7 is an exploded view of the trap, tray, holding arms of FIG. 6.

FIG. 8 is a bottom view of the trap of FIG. 6, with the reservoir removed.

FIG. 9 is side view of the trap, tray, holding arms and stakes in an operable orientation.

FIG. 10 is a top isometric view of the bottom piece of the preferred embodiment of the present invention.

FIG. 11 is a bottom isometric view of the bottom piece of FIG. 10.

FIG. 12 is a frontal view of the preferred embodiment of the hanging device.

FIG. 13 is a rear view of the preferred embodiment of the hanging device.

FIG. 14 is an isometric view of one side of the support bracket.

FIG. 15 is an isometric view of another side of the support bracket of FIG. 14.

FIG. 16 is a sectional view of the wing tip of the support bracket of FIGS. 14 and 15.

### DETAILED DESCRIPTION OF THE INVENTION

The current invention provides a novel and improved multi-piece three-dimensional insect trap and assembly for capturing and monitoring insects. In the assembled form, the trap has a four-sided shape with a peaked center that forms a chamber to hold pheromone vapors, and hip-roofed, for gabled openings on each side permitting easy entry of insects lured by the internal pheromone or kairomone dispenser. When the trap is assembled with either the adhesive-coated floor or with the reservoir holding soapy water or oil, insects are captured and can be counted for population monitoring or can be eliminated from the population by mass trapping.

Multi-Piece Three Dimensional Insect Trap

A multi-piece three dimensional insect monitoring and capturing trap 10 has a unique design suitable for various purposes and is simple, practical and easy to use. The trap's novel design permits its shipping and storing in a stacked unassembled form. The trap's novel locking clasp permits easy assembly, disassembly and handling in the field and permits a reuse after replacing the separate adhesive-coated floor, reservoir or pheromone mating disruption device. One trap may be used for monitoring and capturing insects for one or more monitoring periods and may even last for more than one season. The trap may be manufactured from a variety of materials, including, but not limited to, most all types of rigid plastic or paper. Manufacturing options include thermoplastic or thermosetting plastic, made by all kinds of processes, injection molding and extrusion and vacuum or pressure forming. Paper could include cardboard and card stock, coated with plastic for waterproofing or not.

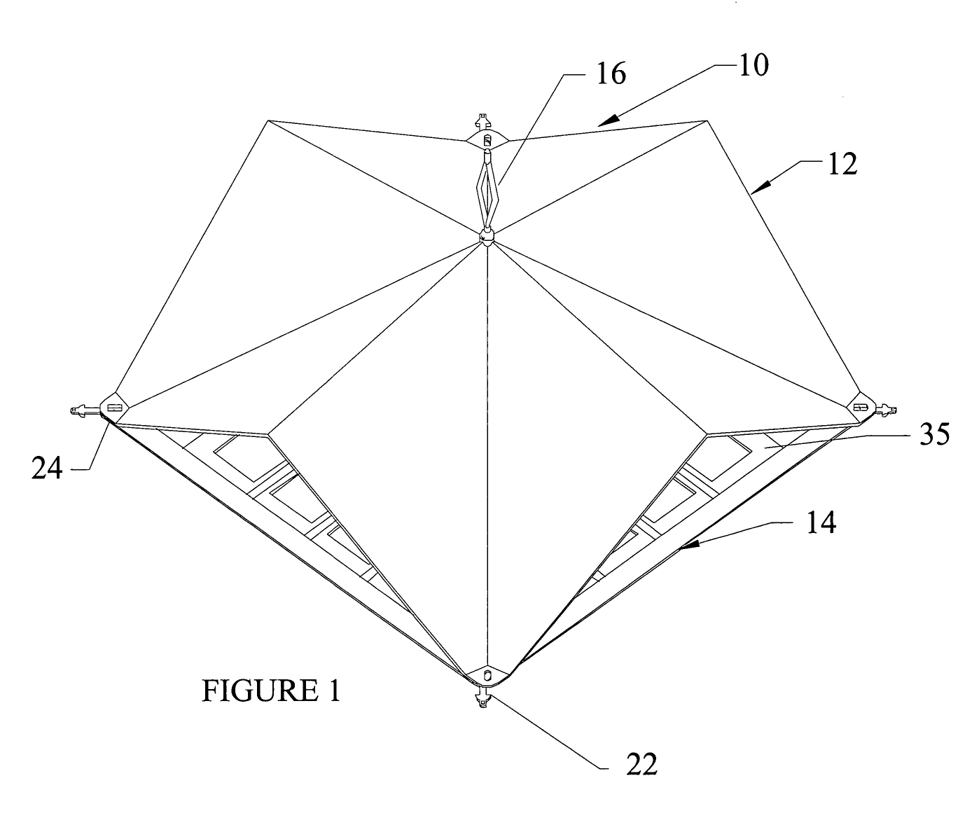

As shown in FIG. 1 the top piece 12 is coupled with the bottom piece 14. Also shown is the device 16 for hanging the trap and for hanging the pheromone or kairomone there from and inside of the trap. The top piece is attached to the bottom piece by inserting the corner locking clasp 22 of the bottom piece into and through the corner holes 24 of the bottom flange of the top piece.

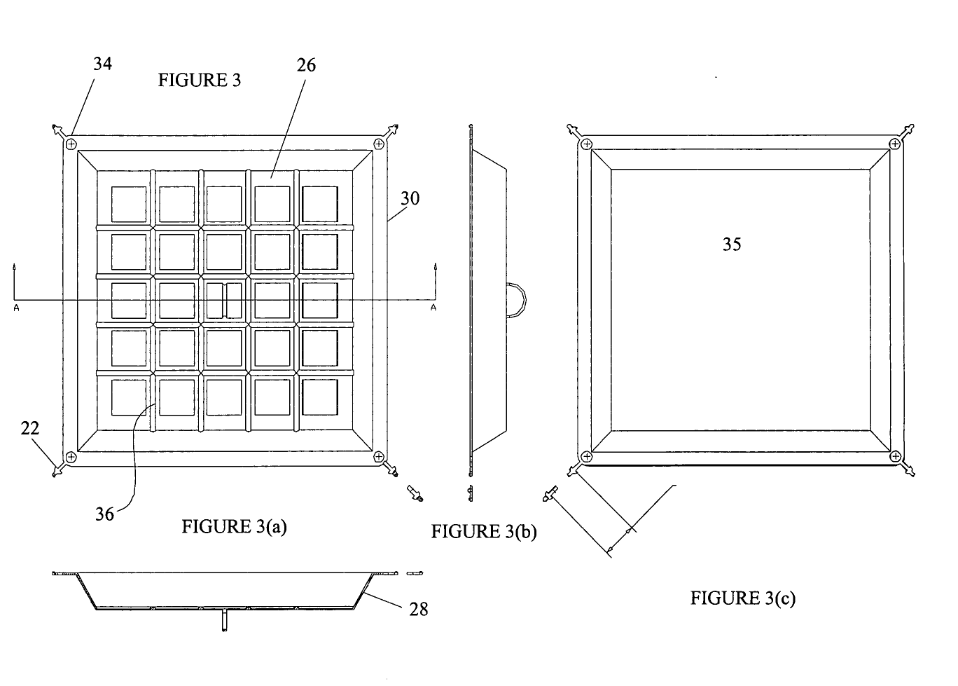

Once the clasp is in position, the wings of the tab lock it in place against the surface of the top piece. With the clasp locked in position, the tab is automatically prevented from being pulled back, through and out of the hole of the top piece by the wings. In FIG. 3, the tab is shown as a single piece. However, the features of the locking clasp in FIG. 3 may be repeated in two or three increments to make the clasp longer, as shown in FIG. 3(c). Having two, three or more increments allows gaps to be created between the top piece and bottom piece when they are coupled together.

The bottom piece 14 of the trap has a floor 26 with at least four side walls 28 projecting there from, with the floor being either solid or grated. At the top edge of the sidewalls is a peripheral shoulder 30 extending from the walls in a plain parallel to the floor. The peripheral shoulder has corner ends 34 with each corner end having locking clasp 22 as the corner tab. The floor is solid 35, as shown in FIG. 3(c), or grid-like 36, as shown in FIG. 3 with a plurality of openings there-through.

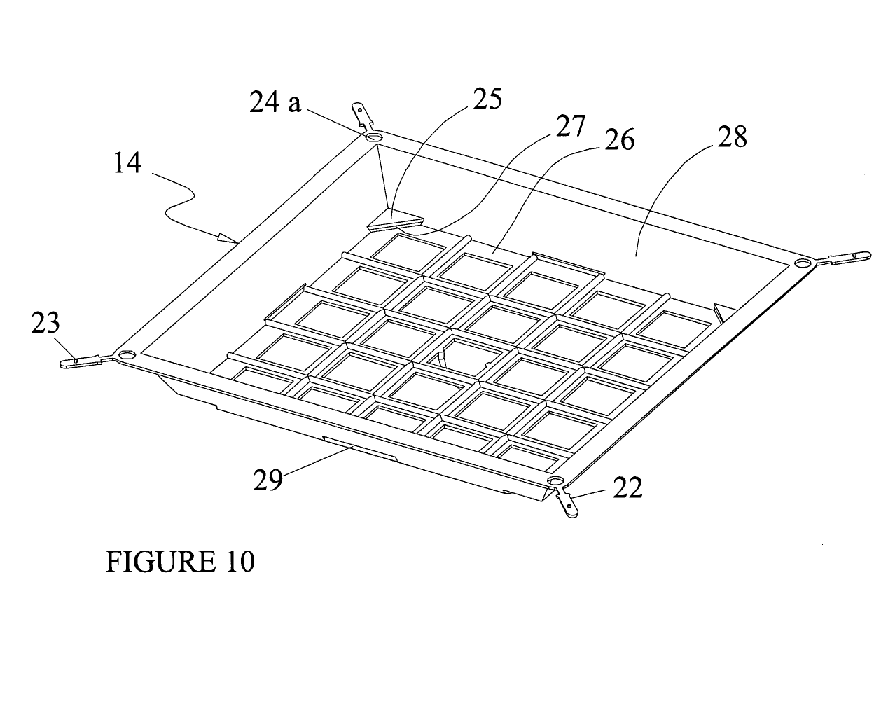

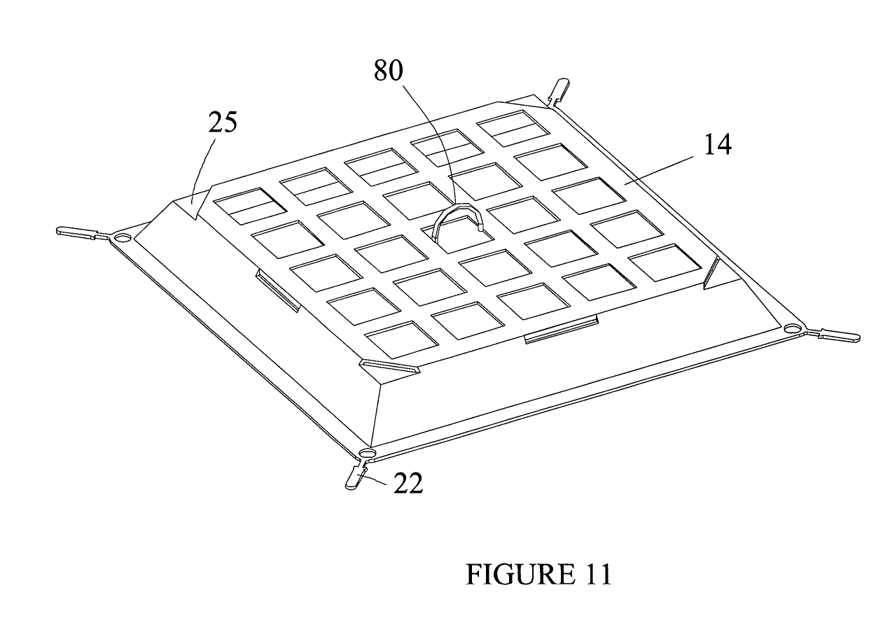

FIGS. 10 and 11 show the preferred embodiment of the bottom piece 14 where the floor 26 has corner members 25 that are elevated a distance above the floor. The corner members have a generally triangular shape. A slot 27 is formed between the edge of the corner members and an edge of a floor corner of the floor. In FIG. 11, the corner members are shown as recessed corners. Further, each of the side walls 28 of the bottom piece has a slit 29 centrally positioned along the corresponding side wall and spaced from the floor of the bottom piece. In FIGS. 10 and 11 slits on opposite side walls are shown to be parallel. However, slits on opposite walls can be positioned such that the slits are off set one from the other. In the rear view of the bottom piece, the slits are clearly shown to be within the side walls.

Additionally, the locking clasp 22 is slighted elongated with a central nodule 23 to assist the wings of the clasp in securing the locking clasp in position. When the corner locking clasp 22 of the bottom piece is inserted into and through the corner holes 24 of the bottom flange of the top piece the nodule acts as a locking mechanism to prevent the locking clasp from slipping out of the corner holes 24 of the top piece. For added security the corner locking clasp can be placed through the corner holes of the top piece and the through the corner holes 24a of the bottom piece. The locking clasp 22 can be removed from it's correspond corner hole when the user applies a small amount of pressure against the nodule with a pulling motion. When the top and bottom piece are fastened together, the corner holes of the top piece will align with the corner holes of he bottom piece.

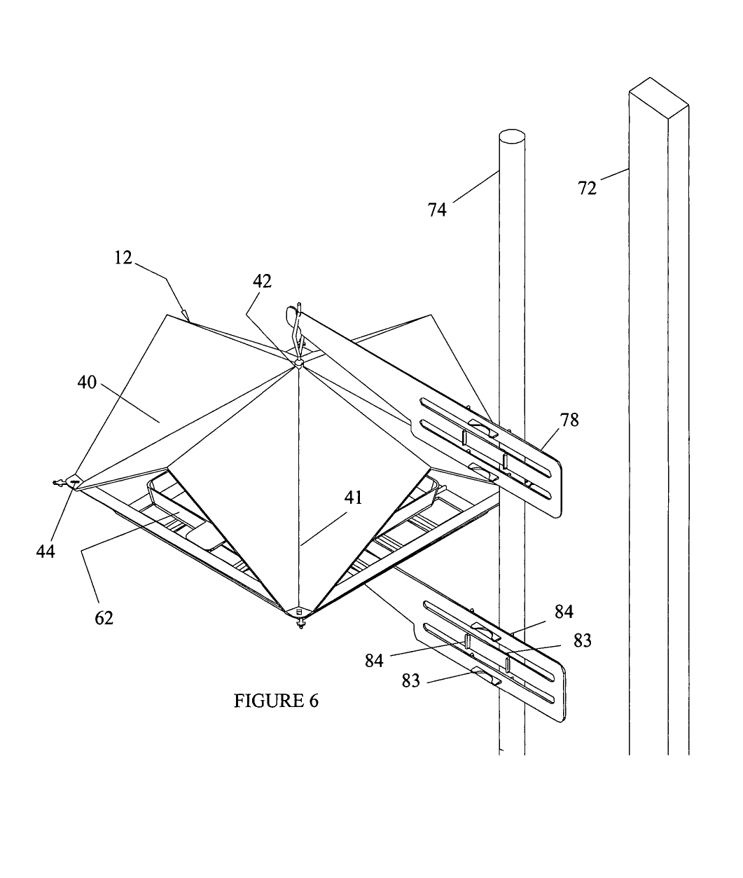

The top piece 12, as shown in FIG. 6, is shaped and sized to have a plurality of generally angular parts 40 with a central peak 42. The central peak has an opening 43. The generally angular parts are gabled with a fold 41 between each adjacent angular part. Extending from each fold and spaced from the central peak is a flange 44, with a corner hole 24.

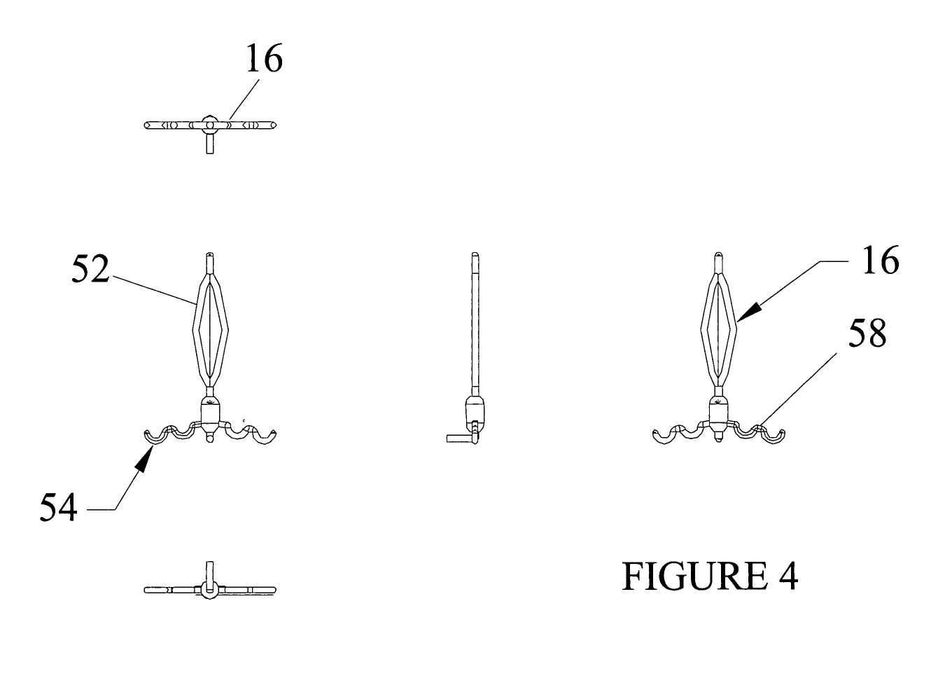

In order to hang the trap, a generally diamond shaped hanging device 16 is provided and shown in FIG. 4. The hanging device is flexible and functions similar to a needle threading device. The hanging device has an upper part 52 and a lower part 54 interconnected with a midsection 55. There is an opening in the upper part of the hanging device. The midsection is sized for a tight fit when placed within the opening of the central peak of the top piece. The hanging device is coupled at the central peak 42 of the top piece 12. The hanging device as currently shown is a separate piece that can be removed from the top piece. It is to be understood that an adhesive can be used to permanently attach the hanging device to the top piece. Lastly, the hanging device can be preformed onto the top piece.

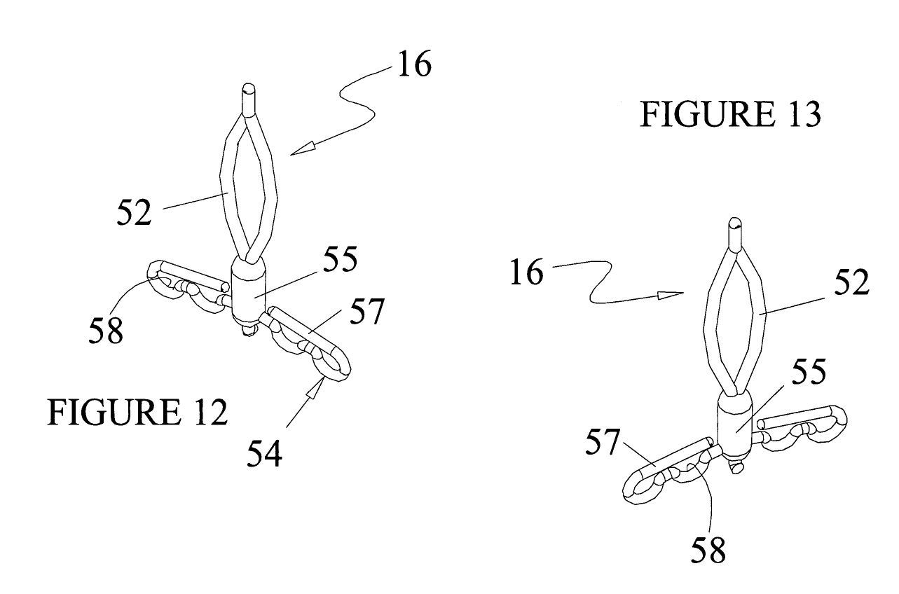

The lower part of the hanging device has a plurality of horizontal projections or arms 58, that are sized and shaped to allow strip cards of insect pheromone or kairomone or attractant to hang there from, and on the inside of the trap, which operate as dispensing arms. Specifically, each horizontal projection has a plurality of concave sections proportionally spaced along the length thereof. Each strip is hung from one of the plurality of concave sections of the arms of the hanging device. As illustrated in FIGS. 12 and 13, the hanging device 16, preferably includes a fastening bar 57 integral the lower part of the hanging device and positioned a distance above the plurality of horizontal projections. The fastening bar ensures that the strip cards of insect pheromone or kairomone or attractant are not blown off of the dispensing arms.

A reservoir 62 is provided. The reservoir is made of a variety of materials that allow it to receive a fluid. The trap may be used with our without the reservoir. When the reservoir is in use, it is placed in the trap and sits on the bottom piece.

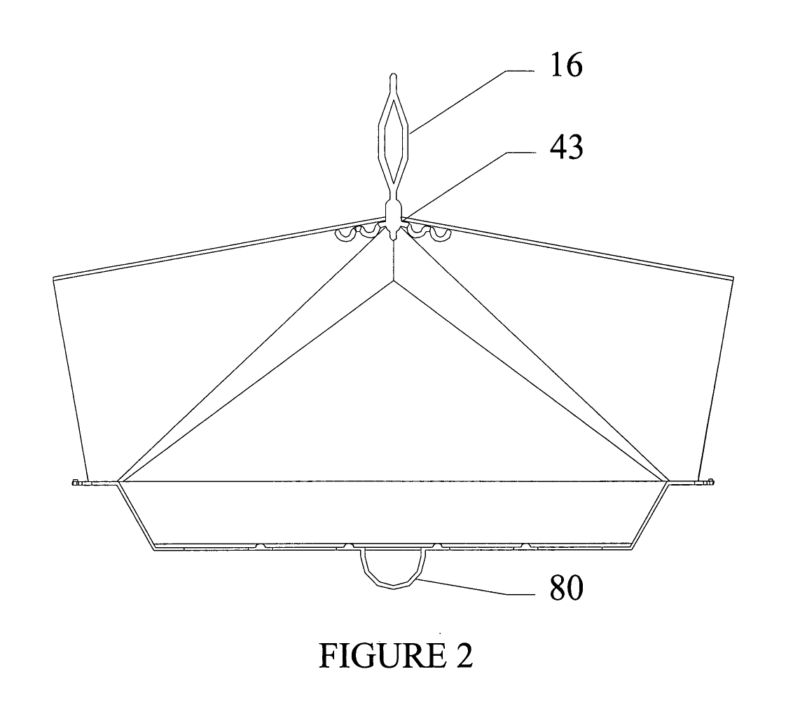

In FIG. 2, a cross-sectional view of the assembled trap is shown with the top piece, bottom piece and hanging device. When the top and bottom piece are assembled, the trap has four sides with openings in a triangular shape resulting from the hip-roofed or gabled shape of the top piece. The top piece can be square or rectangular in shape to match the corresponding bottom. The center point (center peak) of the top piece is the highest point of the trap and includes a round hole that is sized to allow the upper part of the hanging device to pass there-through and extend from the center point of the top piece. The center point is the positioning point for the trap when hung with the hanging device. The top piece can be greater in dimensions than the bottom piece to reduce the likelihood of rain penetration onto the bottom piece.

FIGS. 3 and 3(a) depict the top and cross-sectional views of the bottom piece. The bottom piece is four-sided and can be square or rectangular in shape with vertical sides to match the dimensions of the top piece. When the bottom piece is designed with a grid floor, it allows rain water to drain. A grid bottom allows for attachment of a tether or weight to aid in trap stability in windy conditions.

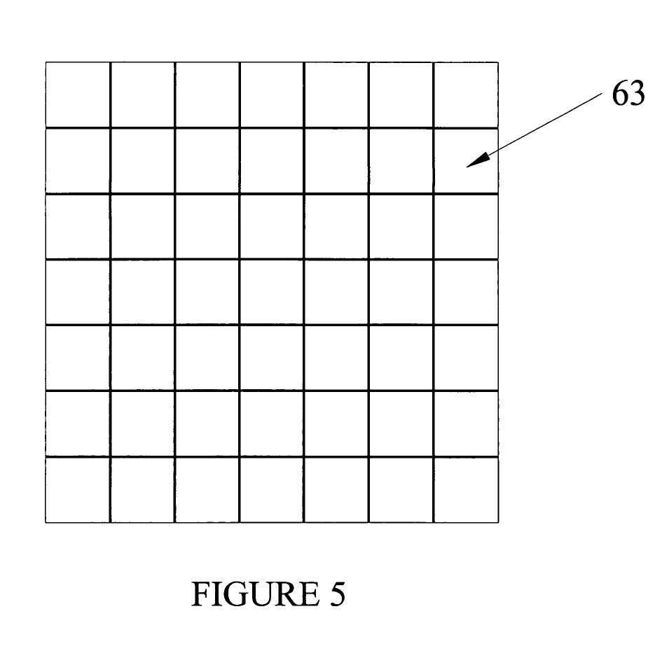

To aid in counting captured insects, a replaceable adhesive-coated floor panel with grid-lines may be positioned within the trap. For storage purposes, the floor panel has a release paper thereon to cover the tacky surfaces prior to use. FIG. 5, shows the replaceable floor panel 63. The floor panel can be made of a variety of materials including coated paper stock. The replaceable floor panel can be positioned within the trap when the bottom piece has a solid or grid-like floor.

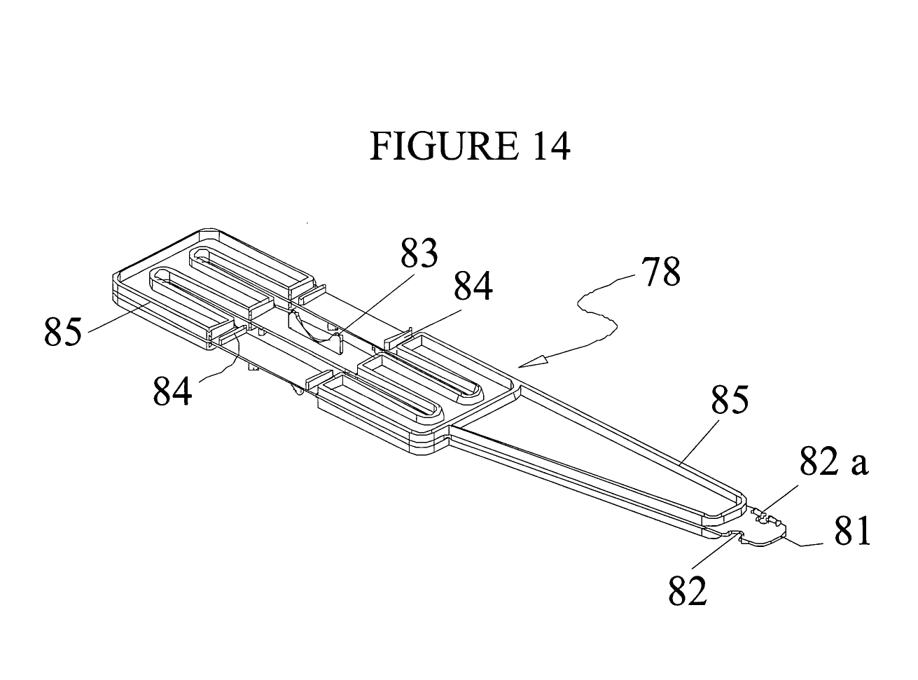

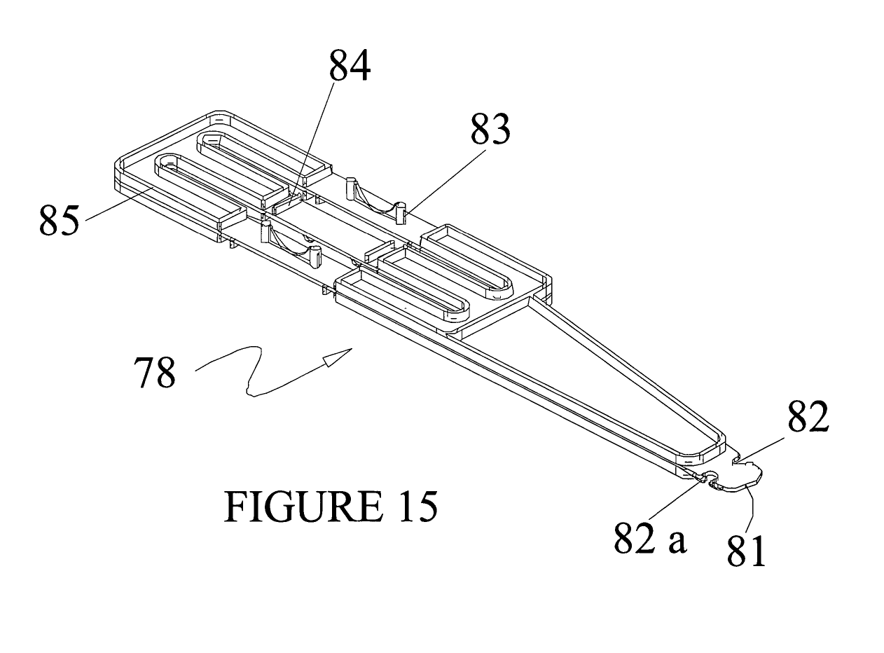

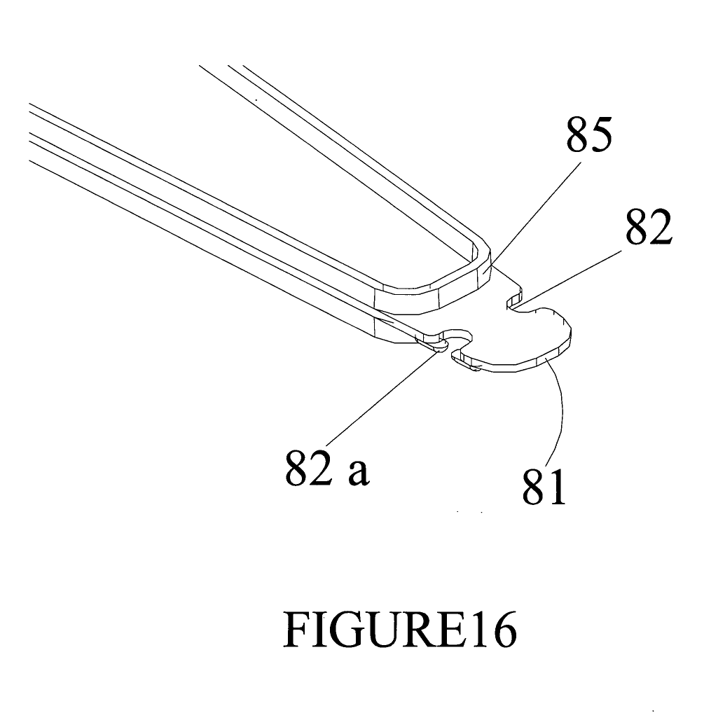

A stake 72 or pole 74, and a pair of support brackets 78 are provided. These items allow positioning of the trap in an area with no trees. As seen in FIGS. 6-8, the width of the back end is greater than the width of the front end of each of the support brackets. Specifically, the rear end of each of the support brackets is slotted for adjustable fastening to the pole or stake. Further, the front end of each of the support brackets has a wing tip 81. The rear of each wing tip has a pair of side channels 82 and at least one of the channels has resilient fastening prongs 82a as best illustrated in FIG. 16. Each support bracket is made of a semi-flexible material that allows the support bracket to be slid onto the stake or pole. Specifically, the support bracket is designed to give three point alignments on either the stake or the pole. As shown in the Figures, each support bracket has a blade 83 preformed on one side of each of the outer slats and a pair of pole supports 84 on an opposite side of each of the outer slats. The center slat has a pair of pole supports on one side and a blade support on an opposite side. The pair of pole supports 84 of the center slat is on the same side of the support bracket as the blade 83 of the outer slats. The blade of the center slat is on the same side of the support bracket of the pole supports of the outer slats. As shown in FIGS. 14 and 15, each of the support brackets can include a framing 85 along the peripheral edges of the support brackets and including the edges of the slots of the back end. The framing provides strength to the structure of the support brackets and increases the coupling effect between the support bracket and its corresponding a stick or pole, when supporting the trap.

In operation when the support brackets are placed over the stake, the center slat is flexed in a direction that prevents the pole supports from engaging the stake, and the two outer slats are flexed in the opposite direction to allow the blades of the outer and center slats to make contact with the stake, thereby locking the support bracket about the stake and prevents the support bracket from sliding down the stake. In the alternative, if a pole is used, then the two outer slats are flexed in a direction to prevent the blades from engaging the pole while the center slat is flexed in the opposite direction so that the pole supports engage the pole, thereby locking the support bracket about the pole.

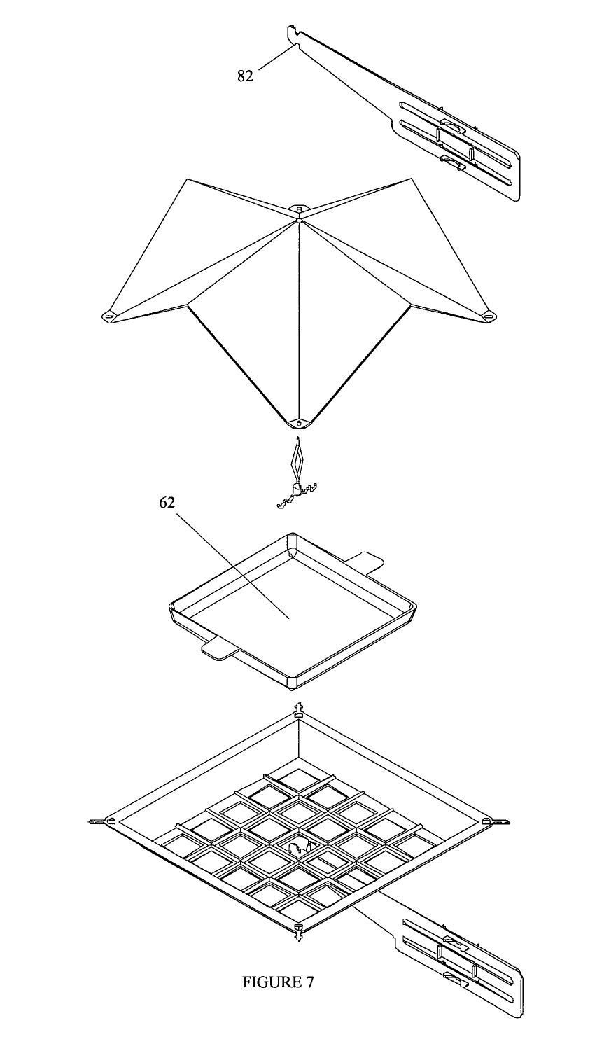

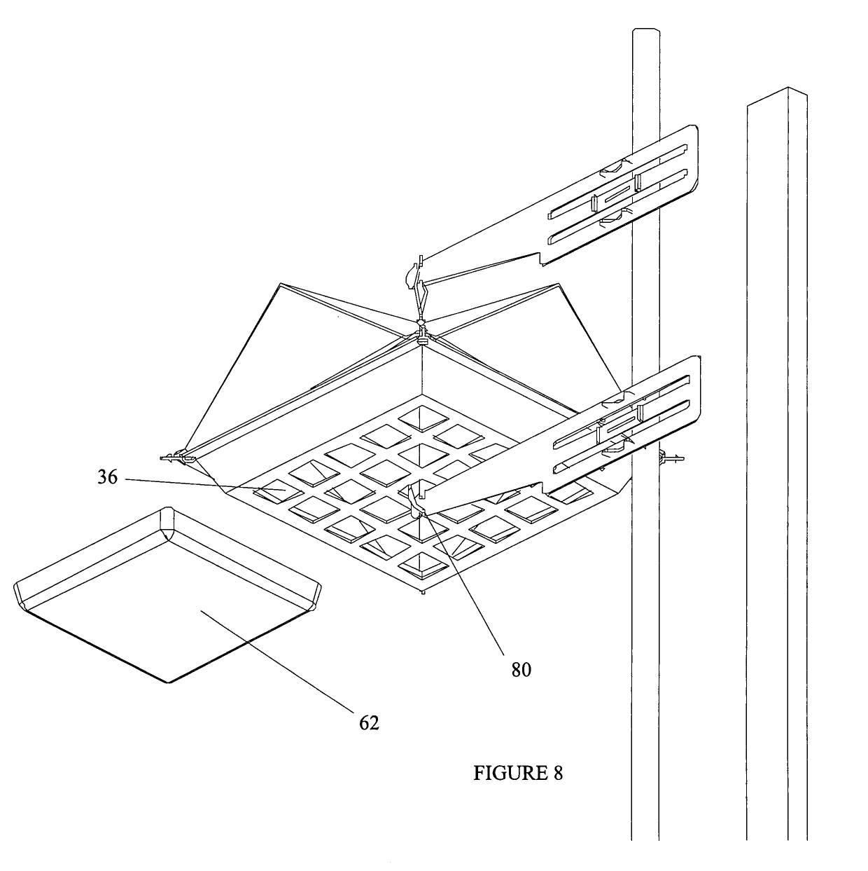

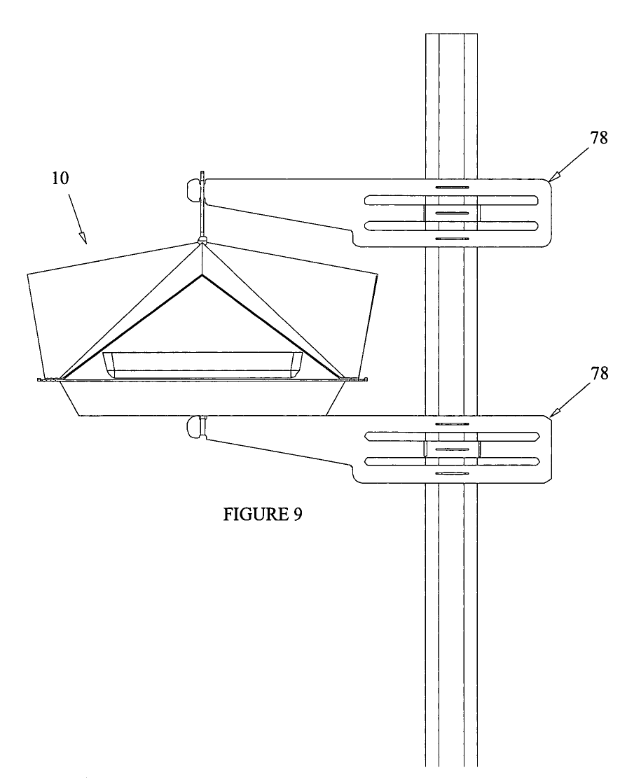

FIGS. 6 and 7 show the assembled trap with mounting arms (support brackets) that support it on the pole. The optional reservoir for holding soapy water or oil is placed on the bottom piece. The support brackets are identical in shape and size. Each support bracket has a support end and a mounting end. Each of the support brackets may be adjustably coupled to the stake or pole to support trap above the ground when a branch or other support structure is unavailable. Also, as shown in FIG. 8, the floor has a flexible fastening member 80 for use with support brackets that mount the trap on a pole or stake.

Trap Design

The basic trap is a three-piece three-dimensional insect trap. The basic trap comprises a square or rectangular bottom piece 14 having vertical sides and a top piece 12 having a raised peak in the middle and four peaked (gabled or hip-roof) sides. A third device, hanging device 16 fits into the top for hanging the pheromone, kairomone or other attractant dispensers and also serves as an anchor point for suspending the trap. Depending upon the desired objective, a replaceable adhesive-coated grid-marked floor can be placed into the bottom piece or a reservoir containing soapy water or oil or a device for dispersing pheromone for mating disruption. If the trap is to be supported above the ground with a stake or pole, arms or brackets are used to provide a rigid mounting system.

The top piece is attached to the bottom piece at the four outside corners. The bottom piece can have alternative designs. In one design, the bottom is of a grid design to allow rainwater to easily pass through while still able to hold a replaceable adhesive-coated floor. An alternate design would have a solid bottom. Either style of bottom allows for the placement of different devices for different purposes. In one option, the placement of a device that treats visiting moths with pheromone would result in a technique known as auto-dissemination. In a second option, a reservoir containing soapy water or oil can be placed on the bottom piece to capture and kill insects attracted into the trap. The third option would be a replaceable floor panel placed into the bottom piece and is coated with adhesive for immobilizing captured insects. The floor panel is marked with a grid pattern to aid in counting the captured insects. The floor panel is easily removed from the bottom piece for counting, removing captured insects or for replacement. The device of FIG. 4 for hanging pheromone, kairomone or other attractant dispensers is attached through the top of the trap at a central point. The dispenser-hanging device also penetrates through the top of the trap and provides an opening for attaching wire, string, cord, or other material for hanging the trap or attaching bracket arms when it is deployed.

The bottom piece in all forms will support a retention card/floor panel 63. The embodiment of FIGS. 10 and 11 are better suited for use with a retention card. The slots 27 of the corner members 25 act as retaining plates to keep the cards with uniform edges in position. Also, having the raised corner members will ensure that the retention cards can be placed within the bottom piece easily and without the need to bend the card into position. Further, it is important that the retention card is not bent because, and pre-bending will cause the retention card to bow during use when the trap has been deployed. Additionally, if the retention card has projections along its peripheral edge, the projections can be easily captured within the slit of the corresponding side wall. The easier it is to place the retention card within the bottom piece and retain the retention card within the bottom piece without the retention card bowing, the better the monitoring results.

An alternate means for deploying the trap is also provided. The support brackets or arms can be attached to the trap for mounting the trap to a pole or stake. These brackets or arms provide for stability in high winds as well as provide a means of mounting when no other structure is available. The brackets or arms are designed to mount onto poles or stakes of various sizes from a pole with a diameter of ½ inch to a stake 2″ in thickness. When the Figure device is hung on the front end of one of the supports brackets, it will rest in the channel while the rear of the wing tip helps to keep the trap from sliding off the support bracket. Likewise, when the trap fastened to a second support bracket at the floor, a flexible fastening member 80 is positioned around the channel of the second bracket

For storage and shipping, the top pieces and bottom pieces are designed to stack neatly minimizing space.

In the assembled form, the trap has a four-sided shape with a peaked roof that forms a chamber for pheromone vapors and a hip-roof opening on each side permitting entry of the insect lured by the pheromone, kairomone or other attractant dispenser. Insects entering the trap are captured by the adhesive coating on the trap floor and can be monitoring by counting the number of insects captured on the grid floor. Alternately, insects entering the trap are captured in a reservoir containing soapy water or oil. Alternately, a device containing pheromone can be placed on the bottom piece for the purpose of mating disruption.

Attachment Means

The trap also has for attachment a trap hanging device 16 for suspending the trap from a tree, bush, and branch or to any other structure where the trap is to be placed. The hanging device (attachment means) passes through or attaches to the top piece of the trap at the center peak 42 to serve as a holding point for pheromone, kairomone or other attractant dispenser. The location of the hanging device on the underside of the top piece is important for creating a reservoir of the odor that can be dispensed through the four peaked openings. The hanging device is designed to hold multiple pheromone or kairomone dispensers. As shown in FIG. 4, the hanging device has the horizontal projections 58 that extend either east and west or north and south. The hanging device can have 2 or more horizontal projections as the number of gables of the top piece increases, to support the strip card of pheromone, kairomone or other attractant. If the trap is to be fixed to a stake or pole, arms or brackets are used to provide a rigid mounting system. The brackets or arms are designed to mount onto poles or stakes of various sizes from a pole with a diameter of ½ inch to a stake in 2″ thickness.

Insect Monitoring and Capturing and Mass Trapping

Due to its novel design, the trap of the invention is especially useful for monitoring a number of insects, including, but not limited to, the orders Lepidoptera, Diptera, Hymenoptera, Hemiptera, Homoptera, Coleoptera, Mecoptera, Trichoptera, Megaloptera, Raphidioptera, Neuroptera. The locking points at all four corners permit the trap to maintain its three-dimensional shape. The pheromone or kairomone Figure inside the trap attracts the insect inside of the trap where the insect is caught and adheres to the adhesive on the trap floor. The trap floor is further imprinted with a grid for easy calculation of captured insects. An alternate means of capturing insects in the trap is to place a reservoir of soapy water or oil in the bottom piece. The use of a reservoir or soapy water or oil is preferred for mass trapping of insect populations but either device may be used.

Monitoring of the number of insects, which is extrapolated to insect infestation, is performed in certain predetermined time periods. For monitoring, the replaceable adhesive-coated floor in each trap unit is easily removed and the number of insects is enumerated or the number of insects per grid is determined. Then the floor may be re-inserted or replaced for continued use of the trap. If killing insects over a prolonged period of time is the objective, a reservoir filled with a layer of soapy water or oil can be employed. The soapy water or oil functions for several weeks before needing to be cleaned and replaced. The soapy water or oil technique and the use of replaceable adhesive-coated floors can be combined in a management scheme to both monitor the level of infestation and eliminate an economically damaging population in a field.

The trap is reusable after being checked by pest control advisers. The replaceable floor is easily removed for insect counting, and if necessary, quickly replaced. This feature is critical for insect monitoring since the time required to check traps in an area is of significant concern to pest control advisors.

Insect Mating Disruption and Auto-Dissemination

Due to its versatile design, the insect trap can be used for the auto-dissemination of sex pheromone for the purpose of mating disruption of flying insects, but not limited to, the orders Lepidoptera, Diptera, Hymenoptera, Hemiptera, Homoptera, Coleoptera, Mecoptera, Trichoptera, Megaloptera, Raphidioptera, Neuroptera. Instead of the replaceable adhesive-coated floor, a device for disseminating effective quantities of insect pheromone can be placed on the bottom piece. An effective number of insect traps can then be placed in the infested area to distribute an effective amount of insect pheromone for the purpose of mating disruption. The trap may also be used for the auto-dissemination of insect growth regulators, biological insecticides and chemical insecticides.

Other Advantages

The trap may be manufactured from a variety of materials, including but not limited to, various kinds of plastic. Manufacturing options include thermoplastic or thermosetting plastic, made by all kinds of processes, injection molding and extrusion and vacuum or pressure forming. Such materials are more durable than coated paper and can last an entire crop cycle and possibly longer. Such durability reduces material and labor costs for insect monitoring and control programs. Paper is a less durable manufacturing option and could include cardboard and card stock, coated with plastic for waterproofing or not.

Also, the top pieces and bottom pieces of the trap can be stacked for easy and less costly shipments. The replaceable floors are flat in shape for easy and inexpensive shipment. The pheromone and trap attachment device is small and is easy and inexpensive to ship.

Also, in those traps where the bottom piece is not solid, the trap allows for easy passage of rain water. A tether or line can be attached to the bottom piece along with a weight to stabilize the trap in areas subjected to high winds. Alternately, brackets and bracing arms can be used to mount the trap onto a stake or pole.

### EXAMPLE 1

### Mass Trapping of Tuta absoluta and the Efficiency of the Insect Trap of the Present Invention

A study was conducted in Lules, Argentina for evaluation of using pheromone-baited monitoring traps for mass trapping to control populations of Tuta absoluta, the tomato leaf miner, in greenhouse tomatoes. In the first experiment, standard Wing Traps (Great Lakes IPM, Verstaburg, Mich.) were baited with slow release dispensers containing synthetic sex pheromone of T. absoluta manufactured by Plato Industries, Ltd. of Houston for the purpose of mass trapping. The Wing Trap was compared to conventional chemical insecticide management. The efficacy of each treatment was determined by monitoring T. absoluta damage in each treatment. As shown in Table 1 and the accompanying figure, mass trapping with pheromone was as effective as conventional insecticide management in maintaining damage from T. absoluta below an economic threshold of two “hits” or infested leaves per plant.

[image]

[image]

In the second experiment, a study was conducted in Cordoba, Argentina in February and March 2003 to compare the effectiveness of the insect trap of the present invention to the Wing Trap (supplied by Great Lakes IPM, Verstaburg, Mich.) in capturing T. absoluta in field grown tomatoes. Ten Wing Traps and ten insect traps of the present invention were installed alternately in a three hectare tomato field. The field was managed for control of T. absoluta with conventional insecticides. Each pheromone trap was baited with a single slow release dispenser loaded with the synthetic version of the T. absoluta sex pheromone manufactured by Plato Industries, Ltd. The moths captured in the traps were counted twice a week and after the second count the trap positions were rotated. For statistical analysis of the captured adult moths the data was converted in daily captures and transformed in to log(x+1) for analysis. The correspondent analyses were made with the statistical program “Statgraphics Plus 3.1”.

The results obtained in this experiment, depicted in Table 2 and the accompanying figure, showed that the insect trap of the present invention was statistically equivalent to the Wing Trap under field conditions. Therefore, the insect trap of the present invention would be effective in both monitoring and mass trapping of T. absoluta. From the operational view, the insect trap of the present invention was easier to assemble, service, and manage than the Wing Trap. For example, in the Wing Trap, the bottom must be disassembled from the trap to count the captured moths. In the insect trap of the present invention, the sticky floor can be quickly removed, the moths counted, and the floor either put back into the trap or replaced with a new floor. Also, the plastic insect trap of the present invention is more durable than the coated paper Wing Trap.

TABLE 2
Captures of adult Tuta absoluta in tomato
fields with pheromone-baited traps

| | Insect trap of the | |
|---|---|---|
| Sample date | present invention | Wing Trap |
| February 13 | 132 | 131 |
| February 18 | 82 | 93 |
| February 21 | 41 | 50 |
| February 25 | 41 | 45 |
| February 28 | 57 | 49 |
| March 3 | 112 | 124 |
| March 6 | 124 | 110 |
| March 11 | 114 | 103 |
| March 14 | 37 | 28 |
| March 18 | 28 | 17 |
| March 22 | 309 | 329 |
| March 26 | 131 | 97 |
| March 31 | 88 | 71 |
| Total | 1296 | 1247 |

[image]

We claim:

1. An insect trap comprising:
a) a bottom piece having a floor with side walls having a peripheral shoulder, the peripheral shoulder having corner ends;
b) a top piece shaped and sized to have a plurality of generally angular parts with a central peak, the generally angular parts having a plurality of flanges, and the number of flanges corresponding to the number of corner ends of the bottom piece;
c) a locking clasp with a nodule, coupling each flange of the top piece to a corresponding corner end of the bottom piece; and
d) a hanging device sized for placement through the central peak of the top piece.

2. The insect trap of claim 2, wherein the assembled trap can be supported above the ground by a stake or a pole and supported thereon by a pair of support brackets, when the hanging device is hung from one of the support brackets and another of the support brackets is coupled with and positioned beneath the bottom piece.

3. The insect trap of claim 1, wherein the floor of the bottom piece having corner members elevated a distance above the floor with a slot formed between an edge of the corner members and an edge of a floor corner of the floor of the bottom piece.

4. The insect trap of claim 1, wherein there are at least four side walls and each of the side walls having a slit centrally positioned along the corresponding side wall and spaced from the floor of the bottom piece.

5. The insect trap of claim 1, wherein the generally angular parts are gabled with a fold between each adjacent angular part, with each fold ending in a flange.

6. The insect trap of claim 1 wherein the assembled trap has a generally triangular insect opening.

7. The insect trap as set forth in claim 1, further including a reservoir for housing a liquid for capturing insects therein.

8. The insect trap as set for the in claim 2, wherein the liquid in the reservoir is a mixture of soap and water or oil and water.

9. The insect trap as set forth in claim 1, further including a removable and replaceable grid-marked floor panel coated with adhesive.

10. The insect trap as set forth in claim 1, further including a device for disseminating an effective amount of an insect attractant for mating disruption.

11. The insect trap of claim 1, wherein the attractant is a pheromone or a kairomone, including but not limited to food attractants and plant volatiles.

12. The insect trap of claim 10, wherein the attractant is a pheromone.

13. The insect trap of claim 7, wherein the trap functions as a mass trapping device.

14. The insect trap of claim 9, wherein the trap functions as a population monitoring device.

15. The insect trap of claim 12, wherein the trap functions as a mating disruption device.

17. The insect trap of claim 12, wherein the trap functions as an auto-disseminating device for insect growth regulators, biological insecticides and chemical insecticides.

17. A method for assembling the insect trap as set for the in claim 1, which is suitable for capturing an insect and for enumerating the number of captured insects, said method comprising the steps of:
a) attaching a top piece to a bottom piece by inserting a locking clasp into a corner hole of a flange of the top piece;
b) hanging a strip card with a pheromone or kairomone or other attractant from a lower part of a hanging device; and
c) inserting the hanging device through a central peak of the top piece.

18. The method for assembling an insect trap as set out in claim 17, further including the steps of positioning a replaceable grid-marked floor panel over a floor of the bottom piece, the replaceable floor panel being coated with an adhesive.

19. The method for assembling an insect trap as set out in claim 17, further including the steps of positioning a reservoir of soap and water or water and oil between the top piece and bottom piece when assembled.

20. The method of assembling an insect trap as set our in claim 17, further including the steps of placing a matting disruption device on the bottom piece.

21. A method for assembling the insect trap as set for the in claim 1, which is suitable for capturing an insect and for enumerating the number of captured insects, said method comprising the steps of:
a) attaching a top piece to a bottom piece by inserting a locking clasp into a corner hole of flange of the top piece;
b) placing pheromone or kairomone or other attractant into a dispensing portion of a hanging device;
c) inserting a hanging device through a central peak of the top piece;
d) coupling a pair of support brackets onto a stake or pole, wherein each of the support brackets having a rear end and a front end, wherein the rear end of each of the support brackets being coupled the stake or pole;
e) positioning the hanging device onto one of the support brackets;
f) positioning another of the support brackets under the bottom piece; and
g) fastening the bottom piece to the other support bracket with a flexible fastening member.

22. An insect trap comprising:
a) a bottom piece;
b) a top piece shaped and sized to have a plurality of generally angular parts with a central peak, the generally angular parts having a plurality of flanges; and
c) the plurality of flanges of the top piece coupling to the bottom piece.

23. The insect trap of claim 22, wherein the bottom piece having a floor with at least four side walls with a peripheral shoulder, the peripheral shoulder having corner ends corresponding to four corners of the side walls and the flanges of the top piece.

24. An insect trap comprising:
a) a bottom piece having a floor with at least four side walls having a peripheral shoulder, the peripheral shoulder having corner ends corresponding to four corners of the side walls, the bottom piece having at least four corner members with a slot between the floor and one of each corner members;
b) a top piece shaped and sized to have a plurality of generally angular parts with a central peak, the generally angular parts being gabled with a fold between each adjacent angular part, with each fold ending in a flange, and the number of flanges corresponding to the number of corner ends of the bottom piece; and
c) one of the corner ends of the bottom piece being coupled with one of the flanges of the top piece.

25. The insect trap of claim 24, wherein each of the side walls having a slit centrally positioned along the corresponding side wall and spaced from the floor of the bottom piece.

26. The insect trap as set forth in claim 24, wherein the bottom piece has a locking clasp that couples each flange of the top piece to a corresponding corner end of the bottom piece.

27. The insect trap as set forth in claim 24 includes, a hanging device with an upper part having an opening and a lower part with a plurality of dispensing arms for dispensing insect attractant, and the plurality of dispensing arms of the lower part further including a fastening bar.
